(19) United States
(12) Patent Application Publication
(10) Pub. No.: US 2020/0271826 A1
(43) Pub. Date: Aug. 27, 2020

(54) Pattern-Guided Dip Estimation

(71) Applicant: Saudi Arabian Oil Company, Dhahran (SA)

(72) Inventors: Yang Zhao, Katy, TX (US); Houzhu Zhang, Houston, TX (US)

(21) Appl. No.: 16/284,767

(22) Filed: Feb. 25, 2019

(51) Int. Cl. G01V 99/00; G01V 1/36; G06T 15/50; G06T 17/05; G06T 15/30

(52) U.S. Cl. CPC G01V 99/005; G01V 1/368; G06T 15/30; G06T 17/05; G06T 15/503

(57) ABSTRACT

Innovative aspects of the subject matter described in this specification may be embodied in methods that include obtaining a seismic data image. A first plane-wave destruction filter dip estimation is applied to the seismic data image to generate an initial dip model. A second plane-wave destruction filter dip estimation is applied to the seismic data image using the initial dip model to generate a pattern-guided dip estimation. The pattern-guided dip estimation is stored in a data store.

### TECHNICAL FIELD

This disclosure relates to seismic data and image processing.

### BACKGROUND

Structural information is often the most important content of seismic images, and it can be extracted for structure-oriented data processing, such as smoothing, interpolation, and picking. Smoothing along structures can enhance structural features while preserving important discontinuities such as faults or channels. Such smoothing has also been used as a model constraint in inversion-based seismic imaging. Interpolation along structures can reconstruct seismic image/model with a meaningful geologic sense, and it has been used in well-log interpolation. Picking along structures can pick horizons for structural interpretation, or the residual moveout in common-image gathers (CIGs) for prestack imaging.

Structural information can be characterized by local dip attribute, which can be estimated by several methods including semblance scanning methods and local structure tensors. Dip estimation methods can estimate an accurate dip from an image that does not include strong conflicting and steep structures.

### SUMMARY

The present disclosure discusses incorporating pattern information of the structural orientation to guide dip estimation and mitigating aliasing issues. When images have very steep structures, such dip estimation methods may suffer from aliasing problem, which can make the dip estimation challenging. The estimated dominant dip from aliased parts are undesirable, as it follows the false aliased structure instead of a true structure. In some implementations, the pattern information is incorporated to provide an initial dip for the plane-wave destruction (PWD) filter. The PWD filter solves a nonlinear inverse problem, and the solution based on the initial dip provided for the inversion. If the initial dip is pattern-related, then there is a large possibility of the estimation being closer to the dip of a true structure than that of an aliased structure. Thus, PWD can lead to a new dip that contains the pattern information and is referred to as pattern-guided dip. In some examples, when the synthetic data is aliased, the dip can be estimated to be of either true or aliased events by providing different initial dips.

Innovative aspects of the subject matter described in this specification may be embodied in methods that include obtaining a seismic data image. A first plane-wave destruction filter dip estimation is applied to the seismic data image to generate an initial dip model. A second plane-wave destruction filter dip estimation is applied to the seismic data image using the initial dip model to generate a pattern-guided dip estimation. The pattern-guided dip estimation is stored in a data store.

Other implementations of these aspects include corresponding systems, apparatus, and computer programs, configured to perform the actions of the methods, encoded on computer storage devices.

These and other implementations may each optionally include one or more of the following features. For instance, the method can include calculating a coherence map based on the seismic data image, clipping the coherence map with a predetermined threshold value, and generating a mask operator in response to the clipping. Applying the first plane-wave destruction filter dip estimation can include applying a first weighting factor to aliasing-affected areas of the seismic data image, and applying a second weighting factor to aliasing-free areas of the seismic data image. The first weighting factor has a value of zero, and the second weighting factor has a value of one. The initial dip model only includes aliasing-free areas of the seismic data image. The pattern-guided dip estimation is a nonlinear inverse estimation. Estimating a structure-oriented interpolated target image using the patterned guided dip estimation.

Particular implementations of the subject matter described in this specification can be implemented so as to realize one or more of the following advantages. For example, implementation of the subject matter mitigate aliasing issues that may exist in the structure-oriented data processing.

The details of one or more implementations of the subject matter described in this disclosure are set forth in the accompanying drawings and the description. Other features, aspects, and advantages of the subject matter will become apparent from the description, the drawings, and the claims.

### BRIEF DESCRIPTION OF THE DRAWINGS

FIG. 1 is a schematic illustration of a system for pattern-guided dip estimation.

FIG. 2A is an original seismic data image.

FIG. 2B is a subsampled image that is an input image for structure-orientated interpolation.

FIG. 3A is an image including an estimated dip.

FIG. 3B is an image of an interpolation result.

FIG. 4A is an image of an initial dip estimation with a mask operator.

FIG. 4B is an image of a new dip estimation using the initial dip estimation.

FIG. 5A is a coherence map for measuring the reliability of a dip estimation.

FIG. 5B is an image of a mask operator by clipping the coherence map.

FIG. 6A is an image of an interpolation result.

FIG. 6B is an image of a difference of the interpolation result and the original image.

FIG. 7 illustrates a flowchart for pattern-guided dip estimation.

FIG. 8 illustrates an example computing environment for implementing the techniques described herein.

### DETAILED DESCRIPTION

The present disclosure describes pattern-guided dip estimation for mitigating aliasing issues present in structure-orientated data processing. Specifically, the patterned-guided dip estimation can include three plane-wave destruction (PWD) filters. The first dip estimation can be for generating a mask operator to distinguish aliasing-free data from aliasing-affected data. The second dip estimation is conducted with only the aliasing-free data, and outputs an initial model for an inversion of the third (ultimate) dip estimation. In some examples, such as identifying residual moveouts on surface-offset common image gathers (CIGs), generation of the mask operator (the first dip estimation) can be optional.

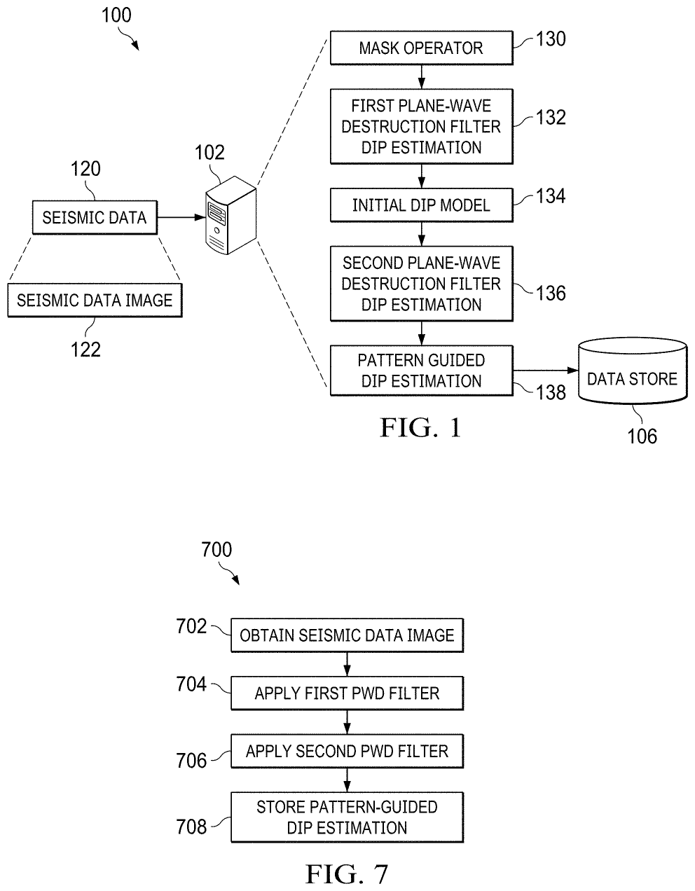

The present disclosure describes a computing system 100 for pattern-guided dip estimation, shown in FIG. 1. The computing system 100 includes a computing device 102 that can be in communication with one or more other computing systems (not shown) over one or more networks (not shown). The system 100 further includes a data store 106, with the computing device 102 in communication with the data store 106.

Dip estimation can be formulated as a regularized nonlinear inverse problem and defined as a least-squares approach in Equation 1:

MD(σ)≈0 [1]

In equation [1], with the smoothing regularization goal on dip σ, D(ν) is the PWD filter, D indicates the known data, M is the mask operator, and the approximately equality indicates minimization of the power of MD(σ). If the estimated dip is accurate, the data after applying the PWD filter should have no (or minimal) energy. To that end, the dip σ in the PWD filter D can be solved using analytical linearization.

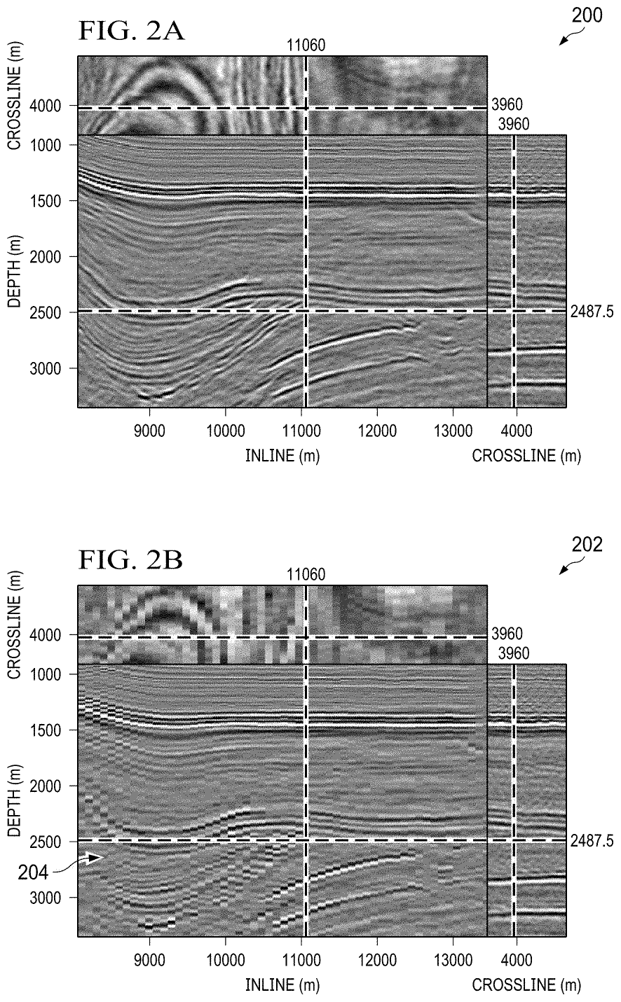

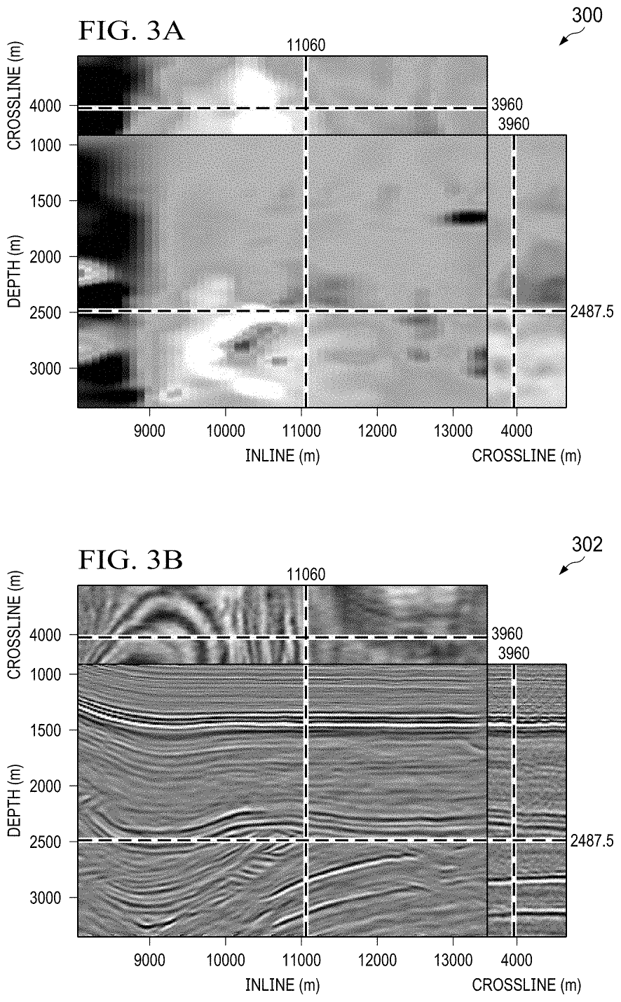

FIG. 2a illustrates a portion of a depth-migrated three-dimensional image 200, including structural folding and angular unconformities. An input image 202 is generated by subsampling an original image (image 200), as shown in FIG. 2B. FIG. 2B illustrates the image 202 including an aliasing issue, as noted by region 204. FIG. 3A illustrates an image 300 including an inline dip estimation using a PWD filter. FIG. 3B illustrates an image 302 subsequent to structure-orientated interpolation of the image 300. To that end, as shown in FIG. 3B, aliasing can result in a wrong orientation of events in the interpolation result; for example, a dip of the events around a depth of 2700 meters and an inline distance of 10,500 meter is opposite to the dip of neighboring events.

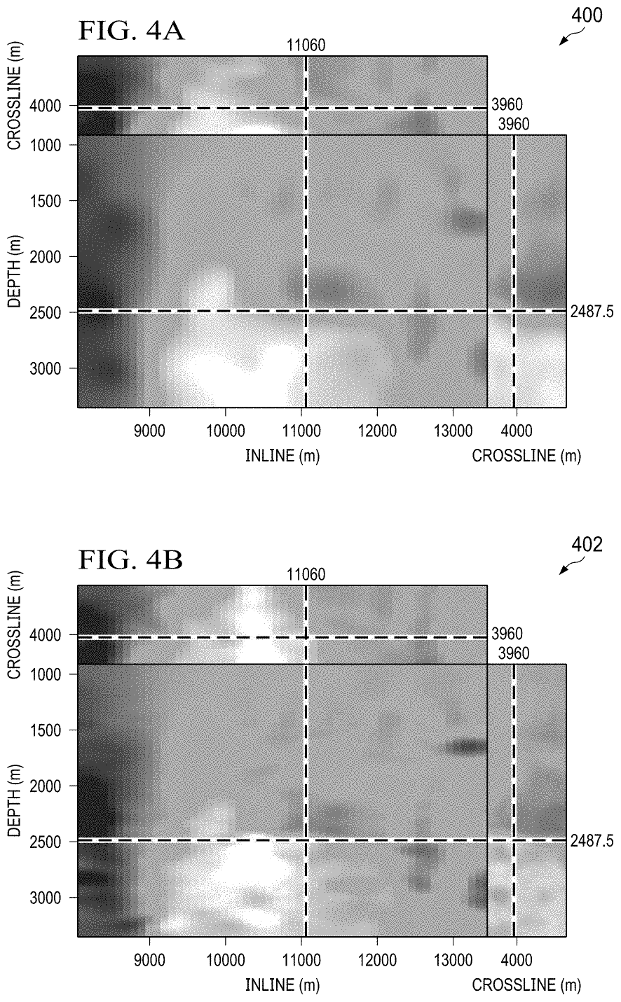

Referring back to FIG. 1, the computing device 102 can receive seismic data 120. The seismic data 120 can include a seismic data image 122. The computing device 102 can apply a first plane-wave destruction (PWD) filter dip estimation 132 to the seismic data image 122 to generate an initial dip model 134. FIG. 4A illustrates an image 400 illustrate a dip in aliasing-affect areas have been adjusted (padded) by smoothing regularization with pattern information. In some examples, only aliasing-free data is used in the first PWD filter dip estimation 132, with the dip in the aliased-affected areas automatically extended by “pattern dip” by smoothing regularization in the inversion of the PWD. In other words, a mask operator 130 is applied in the first PWD filter dip estimation 132. That is, the mask operator 130 applies, in the first PWD filter dip estimation, a value of 1 to aliasing-free areas of the seismic data image 122, and applies a value of 0 to aliasing-affected areas of the seismic data image 122. In some examples, the initial dip model 132 includes only aliasing-free areas of the seismic data image 122.

Back to FIG. 1, the computing device 102 can apply a second PWD filter dip estimation 136 to the seismic data image 122 using the initial dip model 134 to generate a pattern-guided dip estimation 138. FIG. 4B illustrates an image 402 after applying the second PWD filter dip estimation to the seismic data image 122; that is, after refining the initial dip estimation of FIG. 4A to provide the pattern-guided dip estimation 138. In some examples, the pattern-guided dip estimation 138 is a nonlinear inverse estimation. In some examples, the data of the aliased-free areas and the aliased-affected areas of the seismic data image 122 are equally used in the second PWD filter dip estimation 136. Specifically, the smoothing regularization in the second PWD filter dip estimation can be used to fill empty areas of the inversion with the pattern information from the aliasing-free area.

The computing device 102 stores the pattern guided dip estimation 138 in the data store 106.

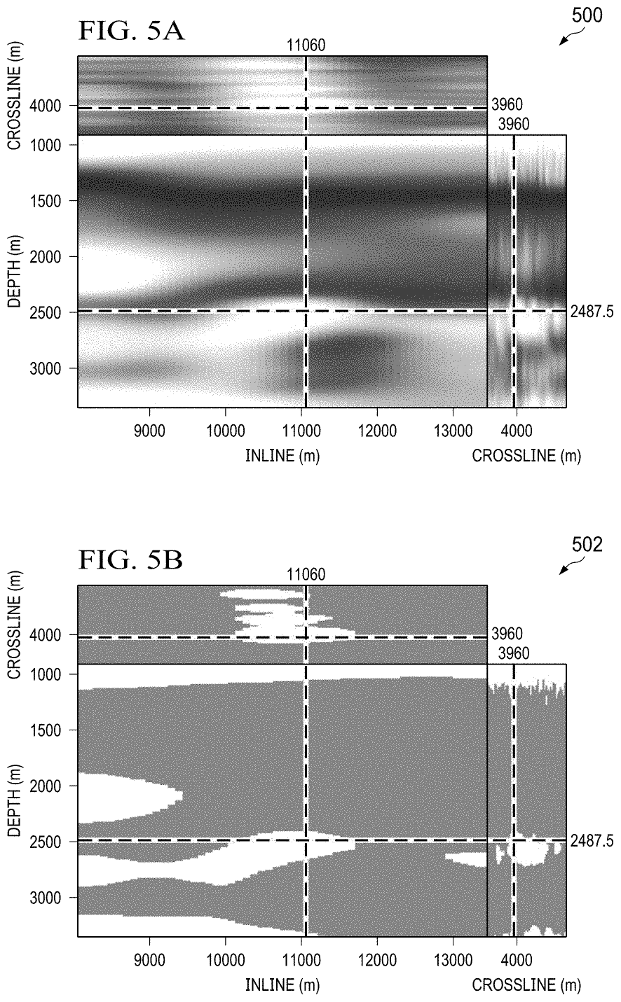

In some examples, the computing device 102 can generate the mask operator 130. Specifically, generating the mask operator 130 can include the computing device 102 calculating a coherence map based on the seismic data image 122. FIG. 5A illustrates a coherence map 500. The coherence map 500 can measure a reliability of a first dip estimation, described further herein. The computing device 102 can clip the coherence map 500 with a predetermined threshold value. For example, with a threshold value of 0.4, the computing device 102 clips the coherence map 500 to generate a mask operator 502, as shown in FIG. 5B.

The computing device 102 can apply the mask operator 130 in the first PWD filter dip estimation 132. Specifically, applying the mask operator 130 in the first PWD filter dip estimation can include applying a first weighting factor to aliasing-affected areas of the seismic data image 122 and applying a second weighting factor to aliasing-free areas of the seismic data image 122. For example, a coherence (or similarity) between a copy of the image and the original image (for example, image 200) evaluates the reliability of an estimated dip. The aliased-affected areas of the seismic data image 122 have a reduced reliability which corresponds to a smaller value in the coherence map (for example, the coherence map 400). In some examples, the first weighting factor is less than the threshold value. For example, for a threshold value of 0.4, the first weighting factor can be 0. In some examples, the second weight factor is greater than the threshold value. For example, for a threshold value of 0.4, the second weighting factor can be 1.

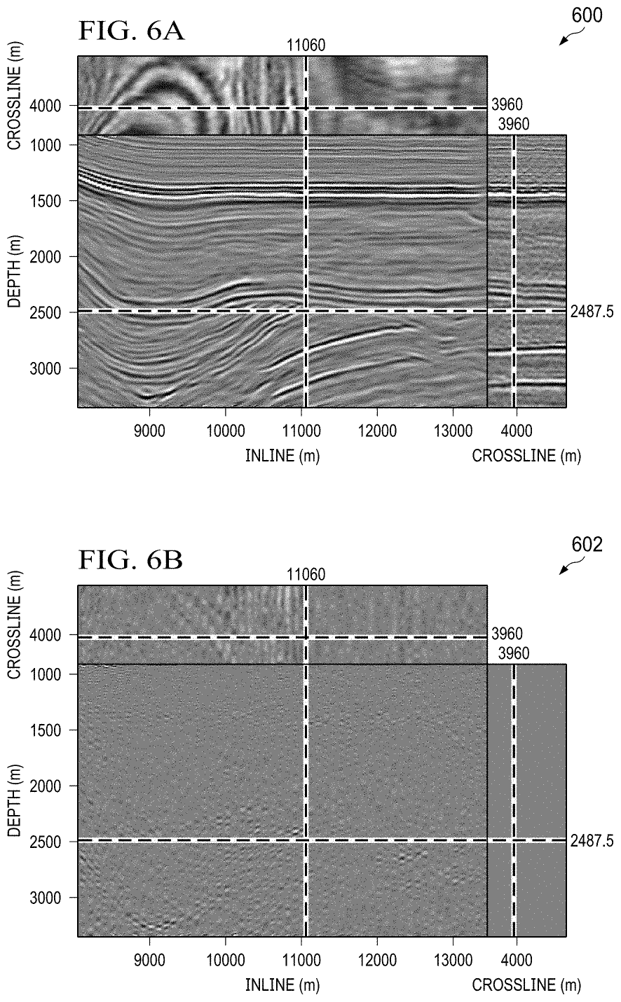

In some examples, the computing device 102 can estimate a structure-orientated interpolated target image using the pattern guided dip estimation 138. Referring to FIG. 6A, an image 600 showing an interpolation result with applying the pattern guided dip estimation 138 to the image 200 of FIG. 2A is shown. FIG. 6B includes an image 602 illustrating the difference between the original image 200 and the image 600, wherein only non-coherent noise can be observed. That is, the interpolation with the pattern guided dip estimation 138 has reconstructed the original image 200 with reduced noise.

In some implementations, such as selecting residual moveout on surface-offset common image gathers (CIGs), performing an additional dip estimation to obtain the mask operator can be optional. That is, the near-offset portion of CIGs can be regarded as aliasing-free areas as events near the offsets have smaller dips that can be unlikely to suffer from aliasing-related issues. In contrast, events at large offsets are more likely to suffer from aliasing as these area are migrated with a bigger accumulated velocity error, leading to larger local dips. Thus, the mask operator 130 can take the value of 1 for near-offset data and 0 for far-offset data.

To that end, predictive paintings can include two steps: dip estimation and spreading information from a seed trace to neighbors recursively by following the dip. The spreading or “painting” can be implemented using plane-wave destruction filters. That is, with a given dip σ, a local operator can be determined to propagate trace sᵢ to trace sⱼ, with such predictions as A_{i,j}. Specifically, if sᵣ is a reference trace, spreading it's information to a distance neighbor sₖ (for example, k>r), can be accomplished using a simple recursion as described in Equation [2]:

sₖ=A_{k-1,k} . . . A_{r+1,r+2}A_{r,r+1}sᵣ [2]

The reference trace for predictive painting can be different depending the application. When selecting residual moveouts in surface-offset CIGs, the reference trace is selected at the zero offset, and its values are set to the depth axis of the CIGs. Painting results are referred to as geologic time, and each contour can represent an event.

For example, for an original image m₀ that includes missing traces or missing data and for a target image m after structure-orientated interpolation, m can be reconstructed using a linear problem. Specifically, the linear model can include the PWD filter D(σ) as a linear operator and m₀ as the initial model. The linear problem can be expressed as Equation [3]:

D(σ)m≈0 subject to Km=m₀ [3]

where K is a diagonal matrix that maintains the know data unchanged. Equation [3] is similar to Equation [1], and the target model of Equation [3] can be m (as opposed to σ in D(σ)) in Equation [1]. Also, the approximate equality can be represent with a known dip σ, and the estimated image can includes zero (or very little) energy after destructing plane waves. The linear problem of Equation [3] can be solved using conjugate gradients. In some examples, interpolation along structures can also be carried though such methods plane-wave shaping regularization.

FIG. 7 illustrates a flow chart that illustrates a method for pattern-guided dip estimation. For clarity of presentation, the description that follows generally describes method 700 in the context of FIGS. 1-6. For example, as illustrated, particular steps of the method 700 may be performed on or at the computing system 100. However, method 700 may be performed, for example, by any other suitable system, environment, software, and hardware, or a combination of systems, environments, software, and hardware as appropriate. Operations of method 700 can include one or more optional steps, including only one or more of the steps being performed, and further, that the steps of FIG. 7 can be performed in any order.

The computing device 102 can obtain the seismic data image 122 (702). The computing device 102 can apply a first plane-wave destruction (PWD) filter dip estimation 132 to the seismic data image 122 to generate an initial dip model 134 (704). In some examples, the mask operator 130 applies, in the first PWD filter dip estimation, a value of 1 to aliasing-free areas of the seismic data image 122, and applies a value of 0 to aliasing-affected areas of the seismic data image 122. The computing device 102 applies a second PWD filter dip estimation 136 to the seismic data image 122 using the initial dip model 134 to generate a pattern-guided dip estimation 138 (706). The computing device 102 stores the pattern guided dip estimation 138 in the data store 106 (708).

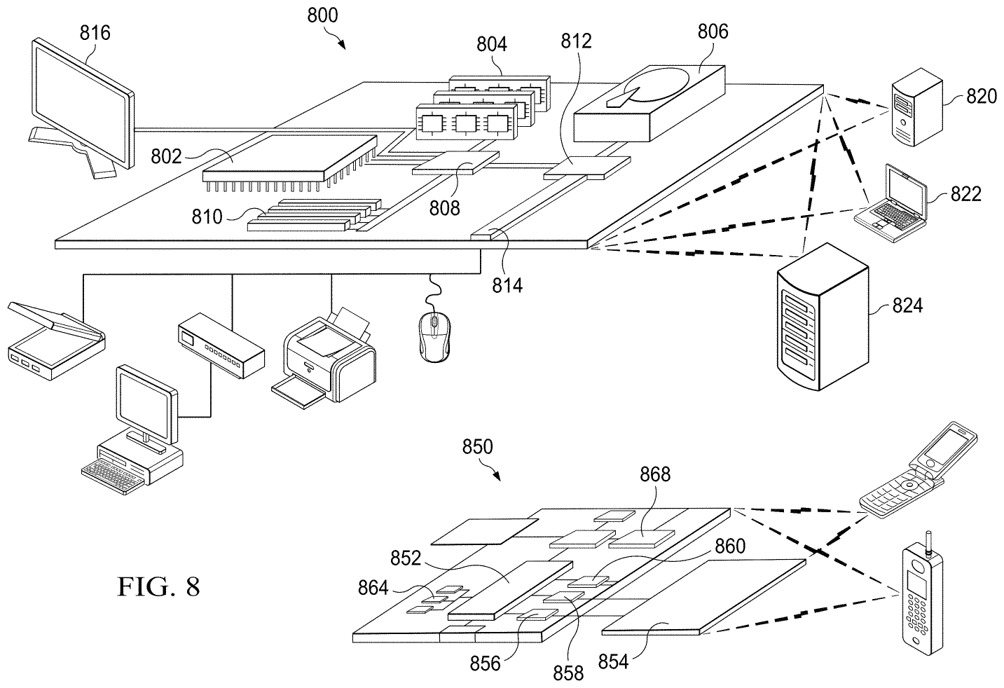

FIG. 8 shows an example of a generic computer device 800 and a generic mobile computer device 850, which may be used with the techniques described here. Computing device 800 is intended to represent various forms of digital computers, such as laptops, desktops, workstations, personal digital assistants, servers, blade servers, and mainframes. Computing device 850 is intended to represent various forms of mobile devices, such as personal digital assistants, cellular telephones, and smartphones. The components shown here, their connections and relationships, and their functions, are meant to be exemplary only and are not meant to limit implementations of the inventions described in this document.

Computing device 800 includes a processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, are interconnected using various busses, and may be mounted on a common motherboard or in other manners as appropriate. The processor 802 may process instructions for execution within the computing device 800, including instructions stored in the memory 804 or on the storage device 806 to display graphical information for a graphical user interface (GUI) on an external input/output device, such as display 816 coupled to high speed interface 808. In other implementations, multiple processors, and multiple buses, or both, may be used, as appropriate, along with multiple memories and types of memory. Also, multiple computing devices 800 may be connected. Each computing device can provide portions of the necessary operations (for example, as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods. The information carrier is a computer- or machine-readable medium, such as the memory 804, the storage device 806, or a memory on processor 802.

The high speed controller 808 manages bandwidth-intensive operations for the computing device 800 The low speed controller 812 manages lower bandwidth-intensive operations. Such allocation of functions is exemplary only. In one implementation, the high-speed controller 808 is coupled to memory 804, display 816 (for example, through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (for example, USB (Universal Serial Bus), Bluetooth, Ethernet, wireless Ethernet) may be coupled to one or more input/output devices, such as a keyboard, a pointing device, a scanner, or a networking device such as a switch or router, for example, through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 860, and a transceiver 868, among other components. The device 850 may also be provided with a storage device, such as a microdrive or other device, to provide additional storage. Each of the components 850, 852, 864, 854, 860, and 868, are interconnected using various buses, and several of the components may be mounted on a common motherboard or in other manners as appropriate.

The processor 852 may execute instructions within the computing device 850, including instructions stored in the memory 864. The processor may be implemented as a chipset of chips that include separate and multiple analog and digital processors. The processor may provide, for example, for coordination of the other components of the device 850, such as control of user interfaces, applications run by device 850, and wireless communication by device 850. Processor 852 may communicate with a user through control interface 858 and display interface 856 coupled to a display 854. The display 854 may be, for example, a TFT LCD (Thin-Film-Transistor Liquid Crystal Display) or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor.

What is claimed is:

1. A method comprising:
obtaining a seismic data image;
applying a first plane-wave destruction filter dip estimation to the seismic data image to generate an initial dip model;
applying a second plane-wave destruction filter dip estimation to the seismic data image using the initial dip model to generate a pattern-guided dip estimation; and
storing, in a data store, the pattern-guided dip estimation.

2. The method of claim 1, further comprising:
calculating a coherence map based on the seismic data image;
clipping the coherence map with a predetermined threshold value; and
in response to the clipping, generating a mask operator.

3. The method of claim 2, further comprising:
applying the mask operator in the first plane-wave destruction filter dip estimation, including:
applying a first weighting factor to aliasing-affected areas of the seismic data image, and
applying a second weighting factor to aliasing-free areas of the seismic data image.

4. The method of claim 3, wherein the first weighting factor has a value of zero, and the second weighting factor has a value of one.

5. The method of claim 3, wherein the initial dip model only includes aliasing-free areas of the seismic data image.

6. The method of claim 1, wherein the pattern-guided dip estimation is a nonlinear inverse estimation.

7. The method of claim 1, estimating a structure-oriented interpolated target image using the patterned guided dip estimation.

8. A system, comprising:
one or more processors; and
a non-transitory computer-readable storage medium coupled to the one or more processors and storing programming instructions for execution by the one or more processors, the programming instructions instruct the one or more processors to:
obtaining a seismic data image;
applying a first plane-wave destruction filter dip estimation to the seismic data image to generate an initial dip model;
applying a second plane-wave destruction filter dip estimation to the seismic data image using the initial dip model to generate a pattern-guided dip estimation; and
storing, in a data store, the pattern-guided dip estimation.

9. The system of claim 8, the operations further comprising:
calculating a coherence map based on the seismic data image;
clipping the coherence map with a predetermined threshold value; and
in response to the clipping, generating a mask operator.

10. The system of claim 9, the operations further comprising:
applying the mask operator in the first plane-wave destruction filter dip estimation, including:
applying a first weighting factor to aliasing-affected areas of the seismic data image, and
applying a second weighting factor to aliasing-free areas of the seismic data image.

11. The system of claim 10, wherein the first weighting factor has a value of zero, and the second weighting factor has a value of one.

12. The system of claim 10, wherein the initial dip model only includes aliasing-free areas of the seismic data image.

13. The system of claim 8, wherein the pattern-guided dip estimation is a nonlinear inverse estimation.

14. The system of claim 8, the operations further comprising estimating a structure-oriented interpolated target image using the patterned guided dip estimation.

15. A non-transitory computer readable medium storing instructions to cause one or more processors to perform operations comprising:
obtaining a seismic data image;
applying a first plane-wave destruction filter dip estimation to the seismic data image to generate an initial dip model;
applying a second plane-wave destruction filter dip estimation to the seismic data image using the initial dip model to generate a pattern-guided dip estimation; and
storing, in a data store, the pattern-guided dip estimation.

16. The computer readable medium of claim 15, the operations further comprising:
calculating a coherence map based on the seismic data image;
clipping the coherence map with a predetermined threshold value; and
in response to the clipping, generating a mask operator.

17. The computer readable medium of claim 16, the operations further comprising:
applying the mask operator in the first plane-wave destruction filter dip estimation, including:
applying a first weighting factor to aliasing-affected areas of the seismic data image, and
applying a second weighting factor to aliasing-free areas of the seismic data image.

18. The computer readable medium of claim 17, wherein the first weighting factor has a value of zero, and the second weighting factor has a value of one.

19. The computer readable medium of claim 17, wherein the initial dip model only includes aliasing-free areas of the seismic data image.

20. The computer readable medium of claim 15, wherein the pattern-guided dip estimation is a nonlinear inverse estimation.
